(19) United States
(12) Patent Application Publication
(10) Pub. No.: US 2022/0076006 A1
(43) Pub. Date: Mar. 10, 2022

(54) METHOD AND DEVICE FOR IMAGE PROCESSING, ELECTRONIC DEVICE AND STORAGE MEDIUM

(71) Applicant: SHENZHEN SENSETIME TECHNOLOGY CO., LTD., Shenzhen (CN)

(72) Inventors: Zhefeng GAO, Shenzhen (CN); Ruodai LI, Shenzhen (CN); Nanqing ZHUANG, Shenzhen (CN); Kun MA, Shenzhen (CN); Yue PENG, Shenzhen (CN)

(73) Assignee: SHENZHEN SENSETIME TECHNOLOGY CO., LTD., Shenzhen (CN)

(21) Appl. No.: 17/455,909

(22) Filed: Nov. 19, 2021

Related U.S. Application Data
(63) Continuation of application No. PCT/CN2020/099580, filed on Jun. 30, 2020.

(30) Foreign Application Priority Data
Sep. 16, 2019 (CN) 201910872325.1

(51) Int. Cl. G06K 9/00; G06K 9/32; G06K 9/46

(52) U.S. Cl. CPC G06K 9/00362; G06K 9/4661; G06K 9/3233; G06K 9/00268

(57) ABSTRACT

A method for image processing includes: performing human shape detection for a target image to obtain a human shape detection result, the target image being acquired in a present scene in real time; determining a region of interest in the target image according to the human shape detection result of the target image; and determining, based on brightness distribution in the region of interest, a target parameter value for image acquisition in the present scene.

### CROSS-REFERENCE TO RELATED APPLICATIONS

This is a continuation of International Application No. PCT/CN2020/099580 filed on Jun. 30, 2020, which is based upon and claims priority to Chinese Patent Application No. 201910872325.1 filed on Sep. 16, 2019. The contents of these applications are incorporated herein by reference in their entirety.

### BACKGROUND

A computer vision technology is a technology of simulating functions of human vision through a device and may be applied to various applications such as artificial intelligence and image processing. For example, in a face recognition scenario, face recognition may be performed for a shot image to determine an identity corresponding to a face.

### SUMMARY

The disclosure relates to the technical field of computer vision, and particularly to a method and device for image processing, an electronic device and a storage medium.

According to an aspect of the disclosure, provided is a method for image processing including: performing human shape detection for a target image to obtain a human shape detection result, the target image being acquired in a present scene in real time; determining a region of interest in the target image according to the human shape detection result of the target image; and determining, based on brightness distribution in the region of interest, a target parameter value for image acquisition in the present scene.

According to another aspect of the disclosure, provided is a device for image processing, including: a detection module, configured to perform human shape detection for a target image to obtain a human shape detection result, the target image being acquired in a present scene in real time; a first determination module, configured to determine a region of interest in the target image according to the human shape detection result of the target image; and a second determination module, configured to determine, based on brightness distribution in the region of interest, a target parameter value for image acquisition in the present scene.

According to another aspect of the disclosure, provided is an electronic device, including: a processor; and a memory configured to store instructions executable for the processor. The processor is configured to: perform human shape detection for a target image to obtain a human shape detection result, the target image being acquired in a present scene in real time; determine a region of interest in the target image according to the human shape detection result of the target image; and determine, based on brightness distribution in the region of interest, a target parameter value for image acquisition in the present scene.

According to an aspect of the disclosure, provided is a non-transitory computer-readable storage medium having stored thereon computer program instructions that, when being executed by a processor, cause the processor to implement following: performing human shape detection for a target image to obtain a human shape detection result, the target image being acquired in a present scene in real time; determining a region of interest in the target image according to the human shape detection result of the target image; and determining, based on brightness distribution in the region of interest, a target parameter value for image acquisition in the present scene.

It is to be understood that the above general description and the following detailed description are only exemplary and explanatory and not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 illustrates a flowchart of an example of a method for image processing according to embodiments of the disclosure.

FIG. 2 illustrates an application scenario diagram of an example of a method for image processing according to embodiments of the disclosure.

FIG. 3 illustrates a flowchart of an example of determining a target parameter value for image acquisition according to embodiments of the disclosure.

FIG. 4 illustrates a flowchart of an example of a method for image processing according to embodiments of the disclosure.

FIG. 5 illustrates a block diagram of an example of a device for image processing according to embodiments of the disclosure.

FIG. 6 illustrates a block diagram of an example of an electronic device according to embodiments of the disclosure.

### DETAILED DESCRIPTION

Various exemplary embodiments, features and aspects of the disclosure will be described below with reference to the drawings in detail. The same reference signs in the drawings represent components with the same or similar functions. Although aspects of the embodiments are illustrated in the drawings, the drawings are not necessarily drawn to scale, unless otherwise specified.

Herein, special term “exemplary” refers to “as an example, as an embodiment or explanatory”. Herein, any embodiment described to be “exemplary” may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple items, or any combination of at least two of multiple items. For example, including at least one of A, B and C may represent including any one or more elements selected from a set formed by A, B and C.

In addition, for describing the disclosure better, many specific details are presented in the following specific embodiments. It is understood by those skilled in the art that the disclosure may still be implemented even without some specific details. In some examples, methods, means, components and circuits well known to those skilled in the art are not described in detail, to highlight the subject of the disclosure.

In face recognition, imaging quality of a face is a main influence factor, and a higher imaging quality helps improving the accuracy of face recognition. However, in a backlighting scene, the imaging quality of a face is relatively poor, which is unfavorable for recognition of a face image and living object determination.

According to an image processing solution provided in the embodiments of the disclosure, human shape detection may be performed for a target image to obtain a human shape detection result, the target image being acquired in a present scene in real time; a region of interest in the target image may be determined according to the human shape detection result of the target image; brightness distribution in the region of interest may be determined according to a brightness of each pixel in the region of interest in the target image; and an acquisition parameter value for image acquisition in the present scene may be determined based on the brightness distribution in the region of interest. In such a manner, the acquisition parameter value suitable for the present scene can be determined through the human shape detection result that is obtained by performing human shape detection for the target image, so that image acquisition may be performed in the present scene according to a determined acquisition parameter. An acquisition parameter may be adjusted according to the determined acquisition parameter value even though the present scene is a backlighting scene or a strong light scene, so that a shot image has relatively high face quality, and the accuracy of subsequent face recognition is improved.

In the embodiments of the disclosure, a target image acquired in real time in the present scene may be obtained, and then human shape detection is performed for the target image to obtain a human shape detection result. Next, a region of interest in the target image is determined according to the human shape detection result of the target image. Finally, an acquisition parameter value for image acquisition in the present scene is determined based on brightness distribution of the determined region of interest. In such a manner, the acquisition parameter value suitable for the present scene may be determined through the human shape detection result obtained by performing human shape detection for the target image, even in a backlighting scene, a strong light scene or other scenes. Thus, an image acquisition device may perform image acquisition in the present scene according to the determined acquisition parameter value, so that an acquired image frame has relatively high face quality, and the subsequent face recognition accuracy is improved.

In a related art, when an image frame is acquired in a backlighting scene, the background brightness of the image frame is high, and a face region in the image frame is dark. The face quality is poor, and the effect of face recognition may be affected. The image processing solution provided in the embodiments of the disclosure is applicable for an environment unfavorable for photographing such as strong light, dark light and backlighting environments, and the imaging quality of faces in various environments may be improved.

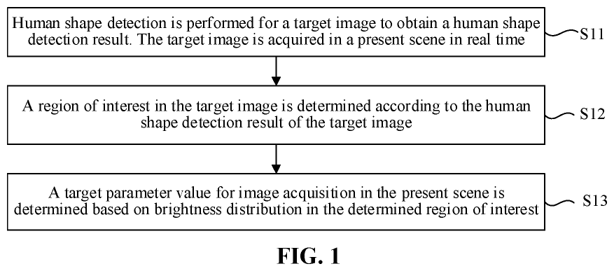

FIG. 1 illustrates a flowchart of a method for image processing according to embodiments of the disclosure. The method for image processing may be executed by a terminal device or another type of electronic device. The terminal device may be an access control device, user equipment (UE), a mobile device, a user terminal, a terminal, a cell phone, a cordless phone, a personal digital assistant (PDA), a handheld device, a computing device, a vehicle-mounted device, a wearable device or the like.

In some possible embodiments, the method for image processing may be implemented by a processor calling computer-readable instructions stored in a memory. The method for image processing according to the embodiments of the disclosure will be described below with an executing subject being an image processing terminal as an example. The image processing terminal may be the abovementioned terminal device or another type of electronic device.

As illustrated in FIG. 1, the method for image processing may include the following operations.

In operation S11, human shape detection is performed for a target image to obtain a human shape detection result. The target image is acquired in a present scene in real time.

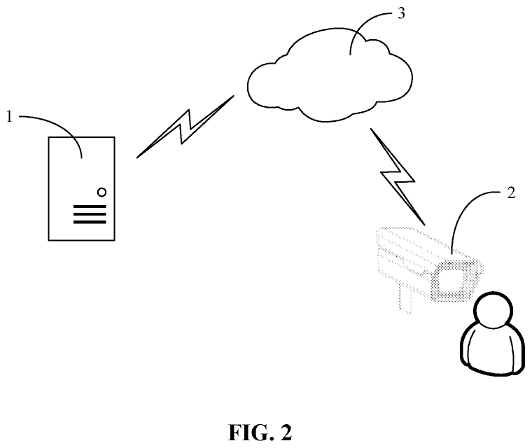

In the embodiments of the disclosure, the image processing terminal 1 may perform real-time image acquisition in the present scene, to obtain the target image acquired in real time. Alternatively, FIG. 2 illustrates an application scenario diagram of an example of a method for image processing according to embodiments of the disclosure. As illustrated in FIG. 2, the image processing terminal 1 may receive, from another device 2 through a network 3, a target image acquired or shot in real time, to obtain the target image acquired in real time. For example, the image processing terminal receives a target image acquired or shot by the another device 2 such as an image acquisition device (for example, a camera or an image sensor) and a video photographing device (for example, a video camera or a monitor) in real time, to obtain the target image acquired in real time. The target image may be an independent image, or, the target image may be an image frame in a video stream. The image processing terminal obtains the target image and performs human shape detection for the target image to obtain the human shape detection result. The human shape detection result may be obtained by detecting some regions in the target image, for example, a detection result of a face region and a detection result of an upper body region.

In a possible embodiment, the image processing terminal may perform human shape detection for the target image by use of a constructed human shape detection network. The human shape detection network may be obtained by training a constructed neural network. As an example, the neural network may be constructed with an existing neural network structure, or a neural network structure may be designed according to a practical application scenario to construct the neural network.

After the neural network is constructed, a training image is input into the constructed neural network. Human shape detection is performed for the training image by use of the constructed neural network, to obtain a human shape detection result. Then the human shape detection result is compared with a labelled result of the training image to obtain a comparison result. A model parameter of the constructed neural network is adjusted by use of the comparison result so that a human shape detection result of the constructed neural network model is consistent with the tagging result. In such a manner, the human shape detection network may be obtained through the constructed neural network model. Herein, an image acquired in a severe photographing environment such as a strong light environment and a dark light environment may be taken as a training image. The human shape detection network may detect a human shape contour in the target image. In a face recognition scenario, the obtained human shape detection result may be a detection result of the face region.

In operation S12, a region of interest in the target image is determined according to the human shape detection result of the target image.

In the embodiments of the disclosure, the image processing terminal may determine, according to the human shape detection result of the target image, whether there is any face region in the target image. The region of interest in the target image may be determined in different manners according to whether there is any face region in the target image. For example, if there is a face region in the target image, the face region may be determined as the region of interest in the target image. If there is no face region in the target image, a certain image region in the target image may be determined as the region of interest in the target image, for example, an image region such as an upper half image region, or a lower half image region may be determined as the region of interest in the target image. Herein, the region of interest may be understood as an image region concerned during image processing, and determining the region of interest in the target image may facilitate further image processing in the region.

In a possible embodiment, in response to that the human shape detection result indicates that there is a face region in the target image, the region of interest in the target image is determined according to the face region in the target image.

In the embodiment, there may be more than one face region in the target image. If the human shape detection result indicates that there is one face region in the target image, the face region may be determined as the region of interest in the target image. If the human shape detection result indicates that there are multiple face regions in the target image, at least one face region may be selected from the multiple face regions, and the selected at least one face region may be determined as the region of interest in the target image. For example, at least one face region at the middle part of the target image is selected from the multiple face regions. As such, the region of interest may be determined according to the face region in the target image, and thus, further image processing may be performed on the determined region of interest, improving the efficiency and accuracy of image processing.

In an example of the embodiment, in response to that there are a plurality of face regions in the target image, a largest face region among the plurality of face regions may be determined, and then the largest face region is determined as the region of interest in the target image.

In the example, if there are multiple face regions in the target image, sizes of the multiple face regions may be compared, and then a largest face region among the multiple face regions may be determined according to a comparison result. Thus, the largest face region may be determined as the region of interest in the target image. In such a manner, a face region that is most concerned may be selected from the multiple face regions as the region of interest, and the remaining image region beyond the region of interest may not be considered during image processing, so that the efficiency and accuracy of image processing can be improved.

In a possible embodiment, in response to that the human shape detection result indicates that there is no face region in the target image, a central image region of the target image may be determined, and then the central image region may be determined as the region of interest in the target image.

In the embodiment, during image acquisition, the face region is usually located in a central image region of the target image, therefore the central image region of the target image may be determined as the region of interest in the target image when no face region is detected through human shape detection. For example, the target image may be divided into multiple image regions. For example, the target image is equally divided into multiple regions such as 9 or 25 regions. Then, the central image region among the multiple regions is determined as the region of interest in the target image. For example, the image region that is at the center of the target image among the 9 image regions is determined as the region of interest. In such a manner, even no face region is detected in the target image, the region of interest in the target image may be determined. Thus, further image processing may be performed on the determined region of interest. The efficiency and accuracy of image processing are improved.

In the embodiments of the disclosure, the region of interest in the target image is determined, and brightness distribution in the region of interest is obtained according to a brightness of each pixel in the region of interest in the target image. The brightness distribution may be represented by a brightness histogram, etc.

In operation S13, a target parameter value for image acquisition in the present scene is determined based on brightness distribution in the region of interest.

The target parameter value for image acquisition in the present scene may be obtained based on the brightness distribution in the region of interest. The target parameter value is a parameter value suitable for a present photographing environment. Under the action of the target parameter value, a well-exposed image with good face quality may be obtained. Thus, adaptability to various severe photographing environments such as a strong light photographing environment and a dark light photographing environment may be achieved.

Herein, an image acquisition parameter needs to be used in image acquisition.

The image acquisition parameter may be a photographing parameter configured in the image acquisition process. The target parameter value is the image acquisition parameter for use in the present scene. The image acquisition parameter or the target parameter value may include one or more of: an exposure value, an exposure duration or a gain. The exposure value is a parameter representing a light transmission capability of a lens, and may be a combination of a shutter speed value and an aperture value. The exposure duration may be a time interval from opening to closing of a shutter. The gain may be an amplification factor for an acquired video signal. The image acquisition parameter may be set. Images photographed in the same scene under different image acquisition parameters may be different. Therefore, an image with good image quality may be obtained by adjusting the image acquisition parameter.

In a possible embodiment, the target parameter value in the present scene is determined, and the image acquisition parameter is adjusted to the target parameter value. Image acquisition is performed in the present scene by use of the target parameter value.

In the embodiment, the image processing terminal may have an image acquisition function to perform photographing in the present scene. The image processing terminal determines the target parameter value for image acquisition in the present scene, sets the image acquisition parameter to be the target parameter value, and continues photographing in the present scene under the action of the target parameter value, to obtain an image acquired after the target image. The image is obtained under the action of the image acquisition parameter being set as the target parameter value. Since the target parameter value is an optimized parameter value, the image has good image quality. In a face recognition scenario, the image has good face quality, so that the speed and accuracy of subsequent face recognition may be improved.

Herein, if the image processing terminal has no image acquisition function, the image processing terminal may send the determined target parameter value to an image acquisition device, so that the image acquisition device may continue photographing in the present scene by use of the target parameter value.

According to the image processing solution provided in the embodiment of the disclosure, the target parameter value for image acquisition may be determined based on the brightness distribution in the region of interest, so that the problem of poor quality of faces photographed in backlighting, strong light, dark light scenes and the like may be solved. The embodiment of the disclosure also provides an embodiment of determining the target parameter value of the image acquisition parameter.

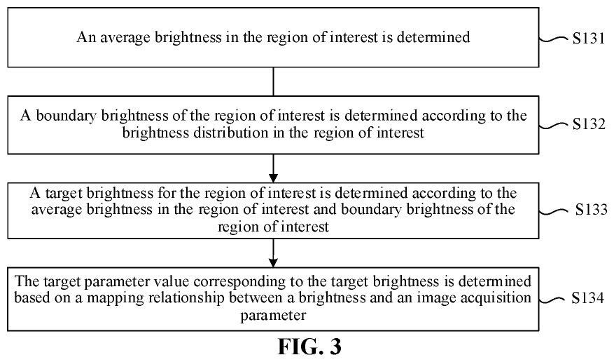

FIG. 3 illustrates a flowchart of an example of determining a target parameter value for image acquisition according to embodiments of the disclosure. As illustrated in FIG. 3, operation S13 may include the following operations.

In operation S131, an average brightness in the region of interest is determined.

Herein, the average brightness in the region of interest may be determined according to a brightness of each pixel in the region of interest. For example, the number of pixels in the region of interest may be statistically obtained; then the brightness of all the pixels in the region of interest are summed to obtain a total brightness of the region of interest, and the total brightness is divided by the number of pixels in the region of interest to obtain the average brightness in the region of interest.

In a possible embodiment, a weight corresponding to each pixel in the region of interest may be determined, and then the average brightness in the region of interest is determined according to one or more weights corresponding to all pixels in the region of interest and the brightnesses of all the pixels.

In the embodiment, a corresponding weight may be set for each pixel in the region of interest. For example, a greater weight is set for a pixel in an image part of more concern in the region of interest, so that a contribution of the image part of more concern may count for a larger proportion when the average brightness in the region of interest is determined. Alternatively, the same weight may be set for all the pixels in the region of interest. For example, when the region of interest is a face region, the same weight value may be set for all the pixels in the region of interest. After the weight corresponding to each pixel in the region of interest is determined, weighted summation is performed on the brightnesses of all pixels, and then the total brightness obtained by the weighted summation is divided by a sum of the one or more weights of all the pixels in the region of interest, to obtain the average brightness in the region of interest.

In an example of the embodiment, in response to that the human shape detection result indicates that there is a face in the target image, the weight corresponding to each pixel in the region of interest may be determined according to a distance between the pixel in the region of interest and a region center of the region of interest. The distance between the pixel and the region center of the region of interest is positively correlated to the weight corresponding to the pixel. The smaller the distance between the pixel and the region center of the region of interest, the greater the weight corresponding to the pixel.

In the example, if the human shape detection result indicates that there is no face region in the target image, the region of interest may be the central image region of the target image. Corresponding weights may be set for the pixels in the region of interest according to the distances from the pixels in the region of interest to the region center of the region of interest. The distance between a pixel and the region center of the region of interest is positively correlated to the weight corresponding to the pixel. For example, a greater weight may be set for a pixel closer to the region center, and a smaller weight may be set for a pixel farther from the region center. That is, a pixel closer to the middle part corresponds to a greater weight. For example, the weight of a pixel in the middle part is 8, the weight of a pixel in an outer part farther from the region center is 4, and the weight of a pixel in an outermost part in the region of interest is 1. Herein, the region of interest may be divided into multiple image parts, and the pixels in each image part may have the same weight. In such a manner, since the probability that the face region is located in the center of the target image is relatively high, a greater weight may be set for the pixels in the middle part to maintain the contribution of the pixels in the face region to the average brightness as much as possible.

In operation S132, a boundary brightness of the region of interest is determined according to the brightness distribution in the region of interest.

Herein, the brightness distribution in the region of interest may be represented by a brightness histogram. An abscissa of the brightness histogram may be a brightness value, and an ordinate of the brightness histogram may be the number of pixels corresponding to the brightness value. The boundary brightness of the region of interest may be determined according to the brightness distribution in the region of interest. The boundary brightness may be a brightness value, and pixels corresponding to the brightness value may include most pixels in the region of interest. Alternatively, the boundary brightness may be a brightness interval, and corresponding pixels in the brightness interval may include most pixels in the region of interest.

In a possible embodiment, the number of corresponding pixels within a brightness reference value range may be determined in the brightness distribution in the region of interest. Then a pixel ratio of the number of corresponding pixels within the brightness reference value range to the total number of pixels in the region of interest is determined. In response to that the pixel ratio is greater than or equal to a preset ratio, the brightness reference value corresponding to the pixel ratio greater than or equal to the preset ratio is determined as the boundary brightness of the region of interest.

In the embodiment, the boundary brightness may be a brightness value. For the brightness histogram of the region of interest, any brightness value may be determined as the brightness reference value to obtain the number of corresponding pixels in the brightness reference value range statistically. The brightness reference value range may be the brightness range from a minimum brightness value to a brightness reference value in the brightness histogram. If the ratio of the number of corresponding pixels in the brightness reference value range to the total number of pixels in the region of interest is greater than or equal to the preset ratio, for example, the ratio of the number of corresponding pixels in the brightness reference value range to the total number of pixels reaches 99%, the brightness reference value may be determined as the boundary brightness.

In operation S133, a target brightness for the region of interest is determined according to the average brightness in the region of interest and boundary brightness of the region of interest.

Herein, the average brightness in the region of interest and the boundary brightness of the region of interest are determined, and the target brightness suitable for the region of interest is determined according to the average brightness in the region of interest and the boundary brightness of the region of interest. Under the target brightness, it may be considered that the pixels in the region of interest have reasonable brightness values such that poor image quality caused by overexposure or underexposure may be avoided. Therefore, the target parameter value of the image acquisition parameter may be determined according to the determined target brightness.

In a possible embodiment, a preset expected boundary brightness may be obtained, and then a ratio of the expected boundary brightness to the boundary brightness is determined. Next, the target brightness for the region of interest is determined according to the ratio of the expected boundary brightness to the boundary brightness of the region of interest and the average brightness in the region of interest.

In the embodiment, the expected boundary brightness may be a boundary brightness determined when an image is exposed well, and may be set according to a practical application scenario. After obtaining the preset expected boundary brightness, the ratio of the expected boundary brightness to the boundary brightness of the region of interest may be calculated; and then the ratio may be multiplied by the average brightness in the region of interest to obtain the target brightness for the region of interest. For example, if the expected boundary brightness is 200 and the boundary brightness of the region of interest is 100, it may be indicated that the average brightness in the region of interest is relatively low, the image quality in the region of interest is relatively poor and there may be some difficulties in face recognition in the region of interest. Therefore, the ratio 2 of the expected boundary brightness 200 to the boundary brightness 100 of the region of interest may be multiplied by the average brightness in the region of interest to obtain the target brightness, the target brightness being twice the average brightness. That is to say, when the average brightness in the region of interest reaches the target brightness, there is good image quality in the region of interest. Therefore, the target parameter value of the image acquisition parameter may be determined according to the determined target brightness, to shoot an image with good face quality under the action of the target parameter value.

In operation S134, the target parameter value corresponding to the target brightness is determined based on a mapping relationship between a brightness and an image acquisition parameter.

Herein, there may be a certain mapping relationship between the brightness of an image and an image acquisition parameter. For example, as an exposure duration of an image is longer, the brightness of the image is higher. Therefore, the target parameter value corresponding to the target brightness may be determined according to the mapping relationship between a brightness and an image acquisition parameter. For example, one or more of the exposure value, the exposure duration and the gain value are determined. Thus, the image processing terminal may adjust the image acquisition parameter to an optimal exposure value.

According to the image processing solution provided in the embodiment of the disclosure, the parameter value suitable for image acquisition in the present scene may be determined according to the human shape detection result obtained by performing human shape detection for the target image. Thus, a shot image can have good face quality even though the present scene is a backlighting scene or a strong light scene, and the subsequent face recognition accuracy is improved.

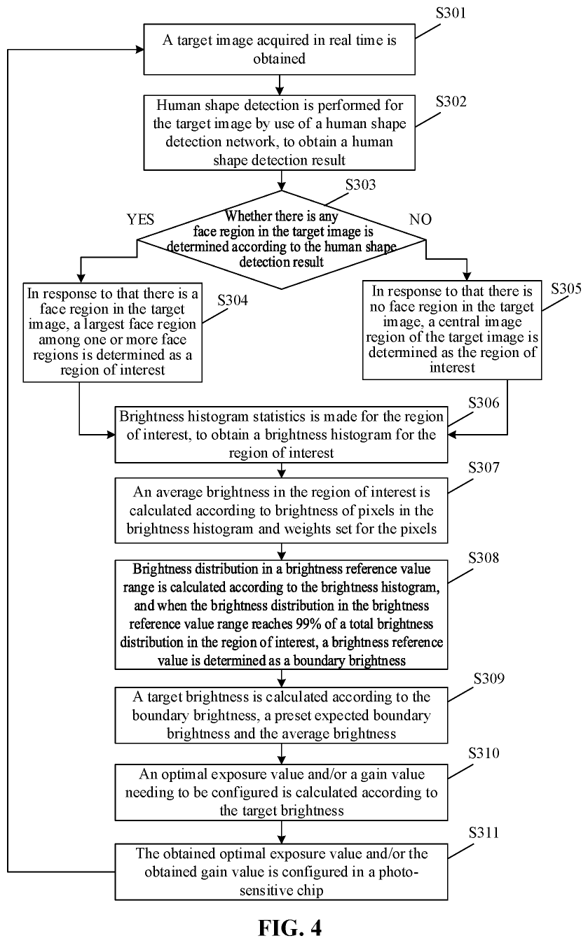

FIG. 4 illustrates a flowchart of an example of a method for image processing according to embodiments of the disclosure. As illustrated in FIG. 4, in an example, the method for image processing may include the following operations.

In operation S301, a target image acquired in real time is obtained.

Herein, an image processing terminal may have an image acquisition function to perform real-time photographing in a present scene. For example, in an access control scene, the image processing terminal acquires, in real time, an image of a user in front of a door to obtain a target image.

In operation S302, human shape detection is performed for the target image by use of a human shape detection network, to obtain a human shape detection result.

Herein, the human shape detection network may be obtained by training a constructed neural network, and the obtained human shape detection result may be a detection result of a face region in the target image.

In operation S303, whether there is any face region in the target image is determined according to the human shape detection result.

In operation S304, in response to that there is a face region in the target image, a largest face region among one or more face regions is determined as a region of interest, and operation S306 is executed.

In operation S305, in response to that there is no face region in the target image, a central image region of the target image is determined as the region of interest, and operation S306 is executed.

Herein, the central image region may be a region where a region center of the target image is located. For example, the target image is equally divided into 9 regions, and the central image region is a middle one among the 9 regions.

In operation S306, brightness histogram statistics is made for the region of interest, to obtain a brightness histogram for the region of interest.

In operation S307, an average brightness in the region of interest is calculated according to brightness of pixels in the brightness histogram and weights set for the pixels.

In operation S308, brightness distribution in a brightness reference value range is calculated according to the brightness histogram, and when the brightness distribution in the brightness reference value range reaches 99% of a total brightness distribution in the region of interest, a brightness reference value is determined as a boundary brightness.

In operation S309, a target brightness is calculated according to the boundary brightness, a preset expected boundary brightness and the average brightness.

In operation S310, an optimal exposure value and/or a gain value needing to be configured is calculated according to the target brightness.

Herein, the optimal exposure value and/or the gain value may be obtained by means of a Proportion-integral-Differential (PID) controller according to the target brightness.

In operation S311, the obtained optimal exposure value and/or the obtained optimal gain value is configured in a photo-sensitive chip, and operation S301 is executed.

Herein, the obtained optimal exposure value and/or the obtained optimal gain value may be configured in the photo-sensitive chip of a camera through an Image Signal Processing (ISP) unit, and then it is continued to acquire a next target image by use of the optimal exposure value and/or the optimal gain value.

According to the image processing solution provided in the embodiment of the disclosure, the face region in the target image is detected by use of the human shape detection network, so as to determine the region of interest. Then the brightness distribution in the region of interest is determined according to the brightness of each pixel in the region of interest in the target image, and the optimal exposure value is obtained based on the brightness distribution in the region of interest. Thus, face image acquisition and face detection in backlighting, dark light and strong light scenes may be implemented well without additional cost, and user experience may be improved.

It can be understood that each method embodiment mentioned in the disclosure may be combined to form combined embodiments without departing from principles and logics. For saving the space, elaborations are omitted in the disclosure.

In addition, the disclosure also provides a device for image processing, an electronic device, a computer-readable storage medium and a program. All of them may be configured to implement any method for image processing provided in the disclosure. Corresponding technical solutions and descriptions refer to the corresponding records in the method part and will not be elaborated herein.

It can be understood by those skilled in the art that, in the method of the specific embodiments, the writing sequence of each step does not mean a strict execution sequence and is not intended to form any limit to the embodiment process and a specific execution sequence of each step should be determined by functions and probable internal logic thereof

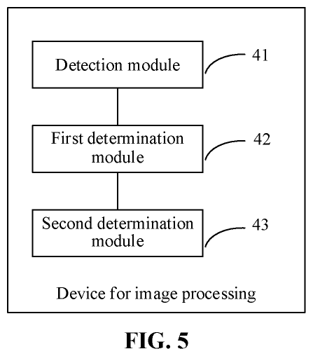

FIG. 5 illustrates a block diagram of a device for image processing according to embodiments of the disclosure. As illustrated in FIG. 5, the device for image processing includes a detection module 41, a first determination module 42 and a second determination module 43.

The detection module 41 is configured to perform human shape detection for a target image to obtain a human shape detection result. The target image being acquired in a present scene in real time.

The first determination module 42 is configured to determine a region of interest in the target image according to the human shape detection result of the target image.

The second determination module 43 is configured to determine, based on brightness distribution in the region of interest, a target parameter value for image acquisition in the present scene.

In a possible embodiment, the first determination module 42 is further configured to: in response to that the human shape detection result indicates that there is a face region in the target image, determine the region of interest in the target image according to the face region in the target image.

In a possible embodiment, the first determination module 42 is further configured to: in response to that there are a plurality of face regions in the target image, determine a largest face region among the plurality of face regions; and determine the largest face region as the region of interest in the target image

In a possible embodiment, the first determination module 42 is further configured to: in response to that the human shape detection result indicates that there is no face region in the target image, determine a central image region of the target image; and determine the central image region as the region of interest in the target image.

In a possible embodiment, the first determination module 42 is further configured to: after the region of interest in the target image is determined according to the human shape detection result of the target image and before the target parameter value for image acquisition in the present scene is determined based on the brightness distribution in the region of interest, determine the brightness distribution in the region of interest according to a brightness of each pixel in the region of interest in the target image.

In a possible embodiment, the second determination module 43 is further configured to: determine an average brightness in the region of interest; determine a boundary brightness of the region of interest according to the brightness distribution in the region of interest; determine a target brightness for the region of interest according to the average brightness in the region of interest and the boundary brightness of the region of interest; and determine the target parameter value corresponding to the target brightness based on a mapping relationship between a brightness and an image acquisition parameter.

In a possible embodiment, the second determination module 43 is further configured to: determine a weight corresponding to each pixel in the region of interest; and determine the average brightness in the region of interest, according to one or more weights corresponding to all pixels in the region of interest and brightnesses of all the pixels in the region of interest.

In a possible embodiment, the second determination module 43 is further configured to: determine the weight corresponding to each pixel in the region of interest according to a distance between the pixel in the region of interest and a region center of the region of interest. The distance between the pixel in the region of interest and the region center of the region of interest is positively correlated to the weight corresponding to the pixel.

In a possible embodiment, the second determination module 43 is further configured to: determine, in the brightness distribution in the region of interest, a number of corresponding pixels within a brightness reference value range. The brightness reference value range is a brightness range from a minimum brightness value to a brightness reference value in the brightness distribution, and the brightness reference value is a brightness value in the brightness distribution. The second determination module 43 is further configured to: determine a pixel ratio of the number of corresponding pixels within the brightness reference value range to a total number of pixels in the region of interest. The second determination module 43 is further configured to: in response to that the pixel ratio is greater than or equal to a preset ratio, determine the brightness reference value as the boundary brightness of the region of interest

In a possible embodiment, the second determination module 43 is further configured to: obtain a preset expected boundary brightness; determine a ratio of the expected boundary brightness to the boundary brightness of the region of interest; and determine the target brightness for the region of interest according to the ratio of the expected boundary brightness to the boundary brightness of the region of interest and the average brightness in the region of interest.

In a possible embodiment, the device further includes an acquisition module, configured to perform image acquisition in the present scene by use of the target parameter value.

In a possible embodiment, the target parameter value includes at least one of: an exposure value; an exposure duration; or a gain.

In some embodiments, functions or modules of the device provided in the embodiments of the disclosure may be configured to execute the method described in the method embodiment, and specific embodiment thereof may refer to the description about the method embodiment, which will not be described herein for simplicity.

The embodiments of the disclosure also disclose a computer-readable storage medium having stored thereon computer program instructions that, when being executed by a processor, cause the processor to implement the above method. The computer-readable storage medium may be a nonvolatile computer-readable storage medium.

The embodiments of the disclosure also disclose an electronic device, including a processor and a memory configured to store instructions executable for the processor. The processor is configured to call the instructions stored in the memory to execute the above method.

The electronic device may be provided as a terminal, a server or a device in another form.

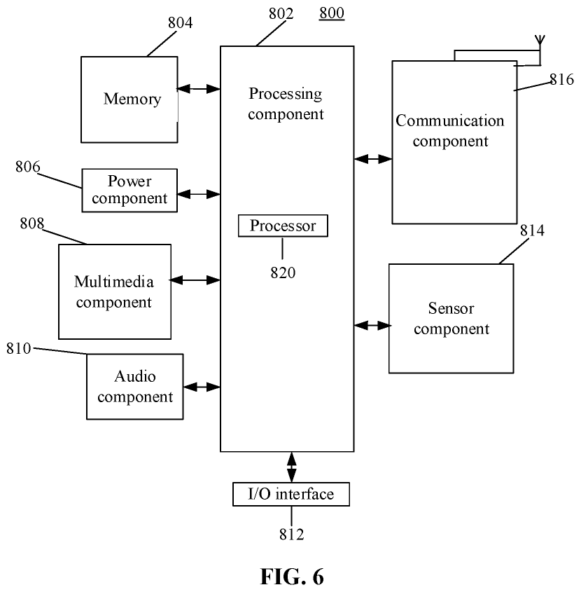

FIG. 6 illustrates a block diagram of an electronic device 800 according to an exemplary embodiment. For example, the electronic device 800 may be a terminal such as a mobile phone, a computer, a digital broadcast terminal, a messaging device, a gaming console, a tablet, medical equipment, fitness equipment or a personal digital assistant.

Referring to FIG. 6, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operation of the electronic device 800, such as operations associated with display, telephone calls, data communications, camera operations, and recording operations. The processing component 802 may include one or more processors 820 to execute instructions to perform all or some of the operations in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, slides and gestures on the TP. The touch sensors may not only sense a boundary of a touch or slide action but also detect a duration and pressure associated with the touch or slide action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in an operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button or the like. The button may include, but not limited to: a home button, a volume button, a start button and a lock button.

The sensor component 814 includes one or more sensors configured to provide status assessment in various aspects for the electronic device 800. For instance, the sensor component 814 may detect an on/off status of the electronic device 800 and relative positioning of components which may be such as a display and small keyboard of the electronic device 800. The sensor component 814 may further detect a change in position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication standard based wireless network, such as a Wireless Fidelity (Wi-Fi) network, a 2^{nd}-Generation (2G), 3^{rd}-Generation (3G), 4^{th}-Generation (4G), or 5^{th}-Generation (5G) network or a combination thereof. In an exemplary embodiment, the communication component 816 receives a broadcast signal from an external broadcast management system or broadcast associated information through a broadcast channel. In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a BlueTooth (BT) technology and other technologies.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, a nonvolatile computer-readable storage medium is also provided, for example, a memory 804 including computer program instructions. The computer program instructions may be executed by a processor 820 of an electronic device 800 to implement the abovementioned method.

The disclosure may be a system, a method and/or a computer program product. The computer program product may include a computer-readable storage medium loaded with computer-readable program instructions for enabling a processor to implement each aspect of the disclosure.

The computer-readable storage medium may be a tangible device capable of retaining and storing instructions used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive listing) of the computer-readable storage medium include a portable computer disk, a hard disk, a Random-Access Memory (RAM), a ROM, an EPROM (or a flash memory), an SRAM, a Compact Disc Read-Only Memory (CD-ROM), a Digital Video Disk (DVD), a memory stick, a floppy disk, a mechanical encoding device, a punched card or in-slot raised structure with an instruction stored therein, and any appropriate combination thereof. Herein, the used computer-readable storage medium is not explained as a transient signal, for example, radio waves or other freely propagating electromagnetic waves, electromagnetic waves propagating through a wave guide or another transmission medium (for example, a light pulse propagating through an optical fiber cable) or an electric signal transmitting through an electric wire.

The computer-readable program instructions described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instructions from the network and forwards the computer-readable program instructions for storage in the computer-readable storage medium in each computing/processing device.

The computer program instructions configured to execute the operations of the disclosure may be assembly instructions, Instruction Set Architecture (ISA) instructions, machine instructions, machine related instructions, microcode, firmware instructions, state setting data or a source code or target code edited by one or any combination of multiple programming languages. The programming languages include an object-oriented programming language such as Smalltalk and C++and a conventional procedural programming language such as “C” language or a similar programming language. The computer-readable program instructions may be completely executed in a computer of a user or partially executed in the computer of the user, executed as an independent software package, executed partially in the computer of the user and partially in a remote computer, or executed completely in the remote server or a server. In response to that the remote computer is involved, the remote computer may be connected to the computer of the user through any type of network including an LAN or a WAN, or may be connected to an external computer (for example, through Internet provided by an Internet service provider). In some embodiments, an electronic circuit such as a programmable logic circuit, an FPGA or a Programmable Logic Array (PLA) may be customized by use of state information of computer-readable program instructions, and the electronic circuit may execute the computer-readable program instructions to implement each aspect of the disclosure.

Herein, various aspects of the disclosure are described with reference to flowcharts and/or block diagrams of the method, device (system) and computer program product according to the embodiments of the disclosure. It is to be understood that each block in the flowcharts and/or the block diagrams and a combination of blocks in the flowcharts and/or the block diagrams may be implemented by computer-readable program instructions.

These computer-readable program instructions may be provided to a processor of a universal computer, a dedicated computer or another programmable data processing device, thereby generating a machine to further generate a device that realizes a function/action specified in one or more blocks in the flowcharts and/or the block diagrams when the instructions are executed through the computer or the processor of the other programmable data processing devices. These computer-readable program instructions may also be stored in a computer-readable storage medium, and through these instructions, the computer, the programmable data processing device and/or another device may work in a specific manner, so that the computer-readable medium stored with the instructions includes a product including instructions for implementing various aspects of the function/action specified in one or more blocks in the flowcharts and/or the block diagrams.

These computer-readable program instructions may also be loaded to a computer, other programmable data processing devices or other devices, so that a series of operating steps are executed in the computer, the other programmable data processing devices or the other devices to generate a process implemented by the computer to further realize the function/action specified in one or more blocks in the flowcharts and/or the block diagrams by the instructions executed in the computer, the other programmable data processing devices or the other devices.

The flowcharts and block diagrams in the drawings illustrate possibly implemented system architectures, functions and operations of the system, method and computer program product according to multiple embodiments of the disclosure. In this regard, each block in the flowcharts or the block diagrams may represent part of a module, a program segment or instructions, and the part of the module, the program segment or the instruction includes one or more executable instructions configured to realize a specified logical function. In some alternative embodiments, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation, or may be implemented by a combination of a special hardware and computer instructions.

Various embodiments of the disclosure have been described above. The above description is exemplary but not exhaustive, and is also not limited to each disclosed embodiment. Many modifications and variations are apparent to those of ordinary skill in the art without departing from the scope and spirit of various embodiments of the disclosure. The terms used herein are selected to explain the principle of various embodiments, practical applications of various embodiments or technical improvements of various embodiments for the technologies in the market best or enable others of ordinary skill in the art to understand various embodiments disclosed herein.

According to the embodiments of the disclosure, a target image acquired in real time in a present scene may be obtained, and then human shape detection is performed for the target image to obtain a human shape detection result. Next, a region of interest in the target image is determined according to the human shape detection result of the target image. Finally, an acquisition parameter value for image acquisition in the present scene is determined based on the brightness distribution in the determined region of interest. In such a manner, the acquisition parameter value suitable for the present scene may be determined through the human shape detection result obtained by performing human shape detection for the target image, even in a backlighting scene, a strong light scene or other scenes. Thus, an image acquisition device may perform image acquisition in the present scene according to the determined acquisition parameter value, so that an acquired image frame has relatively high face quality, and the subsequent face recognition accuracy is improved.

What is claimed is:

1. A method for image processing, comprising:
performing human shape detection for a target image to obtain a human shape detection result, the target image being acquired in a present scene in real time;
determining a region of interest in the target image according to the human shape detection result of the target image; and
determining, based on brightness distribution in the region of interest, a target parameter value for image acquisition in the present scene.

2. The method of claim 1, wherein said determining the region of interest in the target image according to the human shape detection result of the target image comprises:
in response to that the human shape detection result indicates that there is a face region in the target image, determining the region of interest in the target image according to the face region in the target image.

3. The method of claim 2, wherein said determining the region of interest in the target image according to the face region in the target image comprises:
in response to that there are a plurality of face regions in the target image, determining a largest face region among the plurality of face regions; and
determining the largest face region as the region of interest in the target image.

4. The method of claim 1, wherein said determining the region of interest in the target image according to the human shape detection result of the target image comprises:
in response to that the human shape detection result indicates that there is no face region in the target image, determining a central image region of the target image; and
determining the central image region as the region of interest in the target image.

5. The method of claim 1, wherein after said determining the region of interest in the target image according to the human shape detection result of the target image and before determining, based on the brightness distribution in the region of interest, the target parameter value for image acquisition in the present scene, the method further comprises:
determining the brightness distribution in the region of interest according to a brightness of each pixel in the region of interest in the target image.

6. The method of claim 1, wherein said determining, based on the brightness distribution in the region of interest, the target parameter value for image acquisition in the present scene comprises:
determining an average brightness in the region of interest;
determining a boundary brightness of the region of interest according to the brightness distribution in the region of interest;
determining a target brightness for the region of interest according to the average brightness in the region of interest and the boundary brightness of the region of interest; and
determining the target parameter value corresponding to the target brightness based on a mapping relationship between a brightness and an image acquisition parameter.

7. The method of claim 6, wherein said determining the average brightness in the region of interest comprises:
determining a weight corresponding to each pixel in the region of interest; and
determining the average brightness in the region of interest, according to one or more weights corresponding to all pixels in the region of interest and brightnesses of all the pixels in the region of interest.

8. The method of claim 7, wherein said determining the weight corresponding to each pixel in the region of interest comprises:
determining the weight corresponding to each pixel in the region of interest according to a distance between the pixel in the region of interest and a region center of the region of interest, wherein the distance between the pixel in the region of interest and the region center of the region of interest is positively correlated to the weight corresponding to the pixel.

9. The method of claim 6, wherein said determining the boundary brightness of the region of interest according to the brightness distribution in the region of interest comprises:
determining, in the brightness distribution in the region of interest, a number of corresponding pixels within a brightness reference value range, wherein the brightness reference value range is a brightness range from a minimum brightness value to a brightness reference value in the brightness distribution, and the brightness reference value is a brightness value in the brightness distribution;
determining a pixel ratio of the number of corresponding pixels within the brightness reference value range to a total number of pixels in the region of interest; and
in response to that the pixel ratio is greater than or equal to a preset ratio, determining the brightness reference value as the boundary brightness of the region of interest.

10. The method of claim 6, wherein said determining the target brightness for the region of interest according to the average brightness in the region of interest and the boundary brightness of the region of interest comprises:
obtaining a preset expected boundary brightness;
determining a ratio of the expected boundary brightness to the boundary brightness of the region of interest; and
determining the target brightness for the region of interest according to the ratio of the expected boundary brightness to the boundary brightness of the region of interest and the average brightness in the region of interest.

11. The method of claim 1, further comprising:
performing image acquisition in the present scene by use of the target parameter value.

12. A device for image processing, comprising:
a processor; and
a memory configured to store instructions executable for the processor
wherein the processor is configured to call the instructions stored in the memory to:
perform human shape detection for a target image to obtain a human shape detection result, the target image being acquired in a present scene in real time;
determine a region of interest in the target image according to the human shape detection result of the target image; and
determine, based on brightness distribution in the region of interest, a target parameter value for image acquisition in the present scene.

13. The device of claim 12, wherein in determining the region of interest in the target image according to the human shape detection result of the target image, the processor is further configured to:
in response to that the human shape detection result indicates that there is a face region in the target image, determine the region of interest in the target image according to the face region in the target image.

14. The device of claim 13, wherein in determining the region of interest in the target image according to the face region in the target image, the processor is further configured to:
in response to that there are a plurality of face regions in the target image, determine a largest face region among the plurality of face regions; and
determine the largest face region as the region of interest in the target image.

15. The device of claim 12, wherein in determining the region of interest in the target image according to the human shape detection result of the target image, the processor is further configured to:
in response to that the human shape detection result indicates that there is no face region in the target image, determine a central image region of the target image; and
determine the central image region as the region of interest in the target image.

16. The device of claim 12, wherein the processor is further configured to:
after the region of interest in the target image is determined according to the human shape detection result of the target image and before the target parameter value for image acquisition in the present scene is determined based on the brightness distribution in the region of interest, determine the brightness distribution in the region of interest according to a brightness of each pixel in the region of interest in the target image.

17. The device of claim 12, wherein in determining, based on the brightness distribution in the region of interest, the target parameter value for image acquisition in the present scene, the processor is further configured to:
determine an average brightness in the region of interest;
determine a boundary brightness of the region of interest according to the brightness distribution in the region of interest;
determine a target brightness for the region of interest according to the average brightness in the region of interest and the boundary brightness of the region of interest; and
determine the target parameter value corresponding to the target brightness based on a mapping relationship between a brightness and an image acquisition parameter.

18. The device of claim 17, wherein:
in determining the average brightness in the region of interest, the processor is further configured to: determine a weight corresponding to each pixel in the region of interest; and determine the average brightness in the region of interest, according to one or more weights corresponding to all pixels in the region of interest and brightnesses of all the pixels in the region of interest; or in determining the boundary brightness of the region of interest according to the brightness distribution in the region of interest, the processor is further configured to: determine, in the brightness distribution in the region of interest, a number of corresponding pixels within a brightness reference value range, wherein the brightness reference value range is a brightness range from a minimum brightness value to a brightness reference value in the brightness distribution, and the brightness reference value is a brightness value in the brightness distribution; determine a pixel ratio of the number of corresponding pixels within the brightness reference value range to a total number of pixels in the region of interest; and in response to that the pixel ratio is greater than or equal to a preset ratio, determine the brightness reference value as the boundary brightness of the region of interest; or in determining the target brightness for the region of interest according to the average brightness in the region of interest and the boundary brightness of the region of interest, the processor is further configured to: obtain a preset expected boundary brightness; determine a ratio of the expected boundary brightness to the boundary brightness of the region of interest; and determine the target brightness for the region of interest according to the ratio of the expected boundary brightness to the boundary brightness of the region of interest and the average brightness in the region of interest.

19. The device of claim 18, wherein in determining the weight corresponding to each pixel in the region of interest, the processor is further configured to:
determine the weight corresponding to each pixel in the region of interest according to a distance between the pixel in the region of interest and a region center of the region of interest, wherein the distance between the pixel in the region of interest and the region center of the region of interest is positively correlated to the weight corresponding to the pixel.

20. A non-transitory computer-readable storage medium having stored thereon computer program instructions that, when being executed by a processor, cause the processor to implement following:
performing human shape detection for a target image to obtain a human shape detection result, the target image being acquired in a present scene in real time;
determining a region of interest in the target image according to the human shape detection result of the target image; and
determining, based on brightness distribution in the region of interest, a target parameter value for image acquisition in the present scene.
